(19) United States
(12) Patent Application Publication
(10) Pub. No.: US 2012/0153683 A1
(43) Pub. Date: Jun. 21, 2012

(54) VEHICLE ROOF STRUCTURE

(75) Inventors: Scott W. Glaser, Lacon, IL (US); D. Brian Rivara, Peoria, IL (US); Kent M. Levy, Peoria, IL (US); Rafael R. Dela Rosa, Dunlap, IL (US)

(73) Assignee: Caterpillar Inc., Peoria, IL (US)

(21) Appl. No.: 12/972,647

(22) Filed: Dec. 20, 2010

(51) Int. Cl. B62D 25/06; B21D 31/00

(52) U.S. Cl. 296/210; 72/324

(57) ABSTRACT

A method and vehicle roof structure for providing grab handle in vehicle roof structure is disclosed. The vehicle roof structure includes a roof structure frame and a top panel. The top panel is configured to extend from the edges of the roof structure frame to form a roof cap. The roof cap is punched to form a cavity. Further, ejected material from the cavity is molded to form at least one grab handle.

### FIELD OF INVENTION

The present disclosure relates to handles, and more specifically, to a grab handle provided in a vehicle roof structure.

### BACKGROUND OF THE INVENTION

In general assist grip or grab handles are provided in vehicles to provide assistance to driver or passenger while entering or exiting the vehicles. For example, such grab handles are provided in the passenger compartment or climbing ladder to assist the driver. Specifically, in heavy vehicles, such as loader and off highway trucks, the grab handles are separately mounted in a vehicle such that they are used by driver while entering or exiting the vehicle. Typically, the grab handles are welded to a side pillar, a roof bracket or a rail. The grab handle may be mounted, welded or attached through a permanent or a temporary fastener.

Installation of such, grab handles require an additional assembly step. Further, such handles require welding with the body pillars of the vehicle. This requires additional cost and effort during the manufacturing/assembling process.

The disclosed roof structure is directed to overcome one or more of the problems set forth above.

### SUMMARY OF THE INVENTION

In one aspect, the present disclosure is directed to a vehicle roof structure. The vehicle roof structure may include a roof structure frame and a top panel. The top panel extends from the edges of the roof structure frame to form a roof cap. A grab handle formed in the roof cap.

In another aspect, the present disclosure is directed to a method for forming a grab handle in the vehicle roof structure. The method may include providing a roof panel that is extended to form an overhung portion. The overhung portion extends along the periphery of the roof panel. The method may further include forming a cavity in the overhung portion, thereby forming the grab handle in the overhung portion. In yet another aspect, the cavity is punched in the overhung portion. An ejected material from the cavity is molded to form the grab handle.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present disclosure.

FIG. 1 illustrates an exemplary vehicle with the disclosed roof structure;

FIG. 2 is a pictorial illustration of an exemplary disclosed vehicle roof structure; and

FIG. 3 illustrates an alternate view of the exemplary disclosed vehicle roof structure, in accordance with one embodiment of the present disclosure.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present disclosure.

### DETAILED DESCRIPTION

Before describing the embodiments in detail in accordance with the present disclosure, it should be observed that these embodiments reside primarily in a grab handle in a roof of a vehicle and method for manufacturing it. Accordingly, the method steps and the system components have been represented to show only those specific details that are pertinent for an understanding of the embodiments of the present disclosure, and not the details that will be apparent to those with an ordinary skill in the art.

In this document, the terms “comprises,” “comprising,” or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The term “includes”, as used herein, is defined as comprising.

In one embodiment, a vehicle comprising a roof panel having an extended surface forming a roof cap, the roof cap having at least one hole to form at least one grab handle is provided.

In another embodiment, a vehicle roof structure is provided. The vehicle roof structure includes a roof structure frame and a top panel. The top panel is extended from the edges of the roof structure frame to form a roof cap. A grab handle is formed in the roof cap.

In yet another embodiment, a method for forming a grab handle is provided. The method includes providing a roof panel which is extended from the edges to form an overhung portion. The overhung portion extends along the periphery of the roof panel. Further the method includes forming a cavity in the overhung portion. The cavity is punched in the overhung portion. Further, an ejected material from the cavity is molded to form the grab handle.

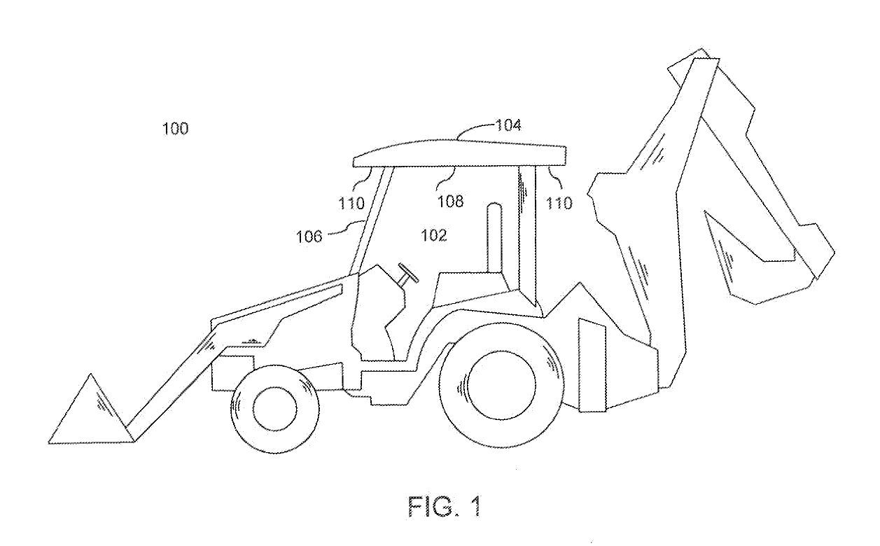

FIG. 1 illustrates an exemplary vehicle 100 where some embodiments of the present disclosure can be practiced. The vehicle 100 can be heavy earth moving equipment or a construction machine. Examples of the vehicle 100 include, but are not limited to, a backhoe loader, a mine truck, a motor grader, a compactor, an excavator, a track type tractor, wheel loaders.

The vehicle 100 includes a driver cabin 102 and a vehicle roof structure 104. The vehicle roof structure 104 includes a roof structure frame 106 and a top panel 108. The driver cabin 102 includes various controls and seating position for the driver of the vehicle 100.

The vehicle roof structure 104 forms the roof of the driver cab 102. The vehicle roof structure 104 includes the roof structure frame 106, and the top panel 108. The roof structure frame 106 is a skeleton structure for mounting the top panel 108. In other words, the roof structure frame 106 forms the pillars and base for mounting the top panel 108. It is understood that the term top panel and roof panel are same and can be used interchangeably.

In one embodiment the top panel 108 is integrated with the pillars to form a vehicle roof structure 104 covering the driver cab 102. The top panel 108 of the roof structure 104 is extended from the edges of the roof structure frame 106 to form a roof cap 110. In other words, the extended surface is an overhung portion forming the roof cap 110. The roof cap 110 can be formed around the periphery of the top panel 108. As represented in FIG. 1 the roof cap 110 can be formed perpendicular to the plane of paper. Further, the roof panel 108 can be extended on all sides of the roof structure 104 to form the roof cap 110.

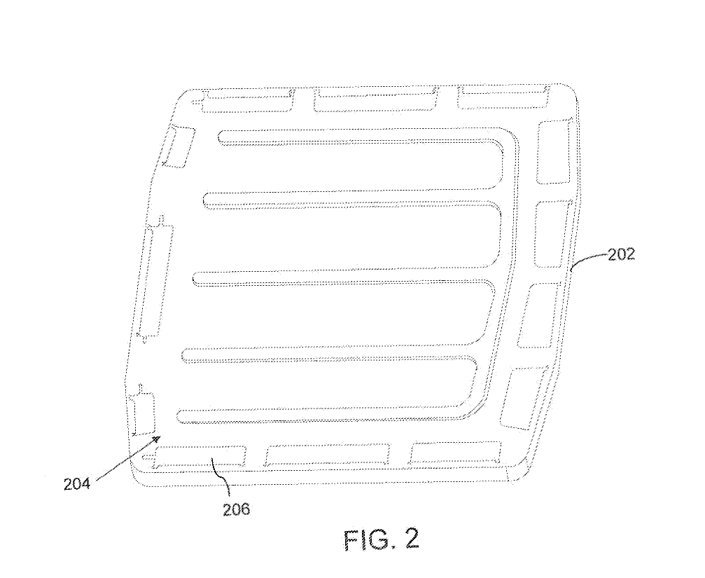

For operating the vehicle, the driver may need climb to reach to the driver cabin 102. Typically the driver grabs a handle to climb up the driver cabin 102. The disclosed vehicle roof structure illustrates the grab handles formed in the roof cap 110. In general, a portion defining at least one hole is formed in the roof cap. The at least one hole in the roof cap 110 forms a grab handle. The grab handle is further described in reference with FIG. 2.

FIG. 2 is a pictorial illustration of an exemplary disclosed roof panel 202. It is understood that the top panel 108 and the roof panel 202 are same and can be used interchangeably. The roof panel 202 is mounted on the roof structure frame as described in FIG. 1. The roof panel 202 includes a surface that is extended to form a roof cap 204. The roof cap 204 is formed by extending the roof panel 202 to provide an overhung portion. The roof panel 202 is extended in a direction parallel to the plane of paper and around the periphery of the roof panel 202. Further, the roof cap 204 includes at least one hole 206. The at least one hole 206 forms at least one grab handle 206. In other words, holes 206 are formed in the roof cap 204 to form grab handles 206. The holes 206 can be punched in the roof cap 204.

In an alternate embodiment, the roof cap 204 and the grab handles 206 can be molded with the casting of the roof panel 202. In other words, the roof panel 202 has the overhung portion with holes 206 forming the grab handles 206 in an integral casting.

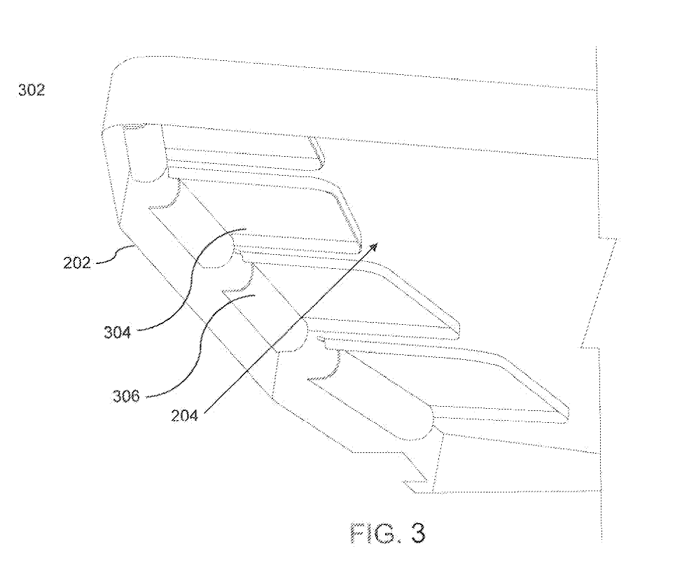

FIG. 3 illustrates an alternate view of the exemplary disclosed vehicle roof structure 302, in accordance with one embodiment of the disclosure. The vehicle roof structure 302 includes a roof panel 202. The roof panel includes a roof cap 204. Further, at least one hole is formed in the roof cap to form a grab handle 304. Furthermore, the grab handle 304 is formed by punching the roof panel 202 to form a cavity. The cavity acts the grab handle 304 for the operator. The cavity can be punched around the periphery of the roof panel 202 to form multiple grab handles 304 at the desired location on the roof cap 204. Moreover, the ejected material during the punching process can be molded as a part of grab handle 306.

Various embodiments of the present disclosure offer one or more advantages. The present disclosure provides for a grab handle in the vehicle roof structure. It is expected that one of ordinary skill, notwithstanding possibly significant effort and many design choices motivated by, for example, available time, current technology and economic considerations, when guided by the concepts and principles disclosed herein, will be readily capable of generating such products with minimal experimentation.

In the foregoing specification, the disclosure and its benefits and advantages have been described with reference to specific embodiments. However, one of ordinary skill in the art would appreciate that various modifications and changes can be made without departing from the scope of the present disclosure, as set forth in the claims below. Accordingly, the specification and figures are to be regarded in an illustrative rather than a restrictive sense, and all such modifications are intended to be included within the scope of the present disclosure. The benefits, advantages, solutions to problems, and any element(s) that may cause any benefit, advantage or solution to occur or become more pronounced are not to be construed as critical, required or essential features or elements of any or all the claims. The disclosure is defined solely by the appended claims, including any amendments made during the pendency of this application, and all equivalents of those claims, as issued.

What is claimed is:

1. A vehicle comprising a roof panel having an extended surface forming a roof cap, the roof cap having at least one hole to form at least one grab handle.

2. The vehicle according to claim 1, wherein the roof cap is an overhung portion of the roof panel.

3. The vehicle according to claim 2, wherein the overhung portion is extended along the periphery of the roof panel.

4. The vehicle according to claim 1, wherein the at least one grab handle is formed by punching a hole in the roof cap.

5. The vehicle according to claim 1, wherein the at least one grab handle comprises a plurality of grab handle.

6. A vehicle roof structure comprising:
a roof structure frame;
a top panel, the top panel extending from the edges of the roof structure frame to form a roof cap; and
a grab handle, the grab handle formed in the roof cap.

7. The top panel according to claim 6, wherein the top panel is extended around the periphery to form the roof cap.

8. The top panel according to claim 6, wherein the roof cap is having a portion defining at least one hole.

9. The roof structure according to claim 8, wherein the at least one hole forms the at least one grab handle.

10. The at least one hole according to claim 9, is formed along the periphery of the roof cap to form a plurality of grab handles.

11. A method for forming a grab handle, the method comprising:
providing an extended roof panel to form an over hung portion; and
forming a cavity in the overhung portion, wherein the cavity forms a grab handle.

12. The method as described in claim 11, wherein forming the cavity comprises:
punching a cavity in the overhung portion;
ejecting punched material from the cavity; and
molding the ejected material to form the grab handle.
